(19) United States
(12) Patent Application Publication
(10) Pub. No.: US 2014/0100910 A1
(43) Pub. Date: Apr. 10, 2014

(54) System and Method for Audits with Automated Data Analysis

(71) Applicant: SAP AG, Walldorf (DE)

(72) Inventors: Ying Zeng, Palo Alto, CA (US); Alex Hsu, Palo Alto, CA (US); Kirandeep Dhillon, Palo Alto, CA (US); Cheng Hu, Palo Alto, CA (US); Richard Choi, Palo Alto, CA (US)

(73) Assignee: SAP AG, Walldorf (DE)

(21) Appl. No.: 13/647,277

(22) Filed: Oct. 8, 2012

(51) Int. Cl. G06Q 10/06

(52) U.S. Cl. 705/7.27

(57) ABSTRACT

Systems and methods for defining and executing platform and language independent audit templates are disclosed. Each audit template can include a number of audit task templates. The audit task templates include general instructions for performing an audit task. Each audit task template can be instantiated as an audit task in an associated audit operation that includes organization or process specific information. Each audit task template and audit task can be linked with one or more business rules. Such business rules include translation logic for translating requirements of each audit task into a format expected by specific program, located in a central management system, invoked to operate on the required target business data. The business rules can also include translation data for interpreting the results returned from such programs. The audits operation or business rules can also include deficiency criteria, or alert conditions for initiating audit issues and remediation workflows.

### CROSS REFERENCE TO RELATED APPLICATIONS

Not applicable.

### BACKGROUND

The present invention relates to techniques for performing various types of accounting and financial audits, and in particular, to systems and methods for performing repeatable and consistent audits with automated data analysis.

Unless otherwise indicated herein, the approaches described in this section are not prior art to the claims in this application and are not admitted to be prior art by inclusion in this section.

Due to increased scrutiny from shareholders, consumers, and government regulators, businesses are under increased pressure to provide fair and impartial audits of all aspects of their operations and accounting practices. Most business conditions and statuses ranging from confirmations of inventory to stock offerings and sales, governed by the SEC, must now be checked and reported to various parties of interest. To perform such audits, businesses can either hire an outside third-party auditor or maintain internal audit department. In either case, the task of auditing even a small to medium size company can consume an inordinate amount of a business' resources in the form time, money, manpower, and computing band width.

While various software and business wide computing solutions exist to aid auditors during an audit, running an audit still requires querying and checking vast amounts of business data to ensure compliance with various rules, regulations, and practices. Once all the queries and checks are run, reports must be generated. Even though large scale and comprehensive business management system, such enterprise resource planning (ERP) systems, help in the automation of various business data transaction, in general, performing the checks, queries, and reports is a manual process before, during, and after which a user, such as an auditor, account, or analyst, must perform various individual tasks.

In addition to contributing to the cost in terms of time, money, and manpower required to run an audit, the manual aspects of an audit also introduce inconsistency into the process from audit-period to audit-period. At the beginning of every audit, one or more account/audit professional perform at least one general assessment to determine the general course for the audit. The general course for the audit will determine which checks, queries, and reports will be run or generated. Due to changes in personnel, auditors, business conditions, business systems, regulations, and other variables, the scope and approach of the general assessment can change from audit-period to audit-period. As such, the general course, and consequently the number and types of checks, queries, and reports that are generated will also change from audit to audit. Accordingly, the inclusion of human auditors at the beginning of the audit process to formulate the general audit assessment introduces undesirable expense, delay, inconsistency, and possible omissions.

Thus, there is a need for improved systems and methods for quickly and consistently checking business data during an audit with harmonized results for efficient audit issue creation and resolution. The present invention solves these and other problems by providing systems and methods for platform agnostic automated audit template creation, maintenance, retrieval, and use.

### SUMMARY

Embodiments of the present invention are directed toward techniques for systems and methods for automated design-time and run-time tools for audits with automated data analysis. For example, some embodiments are directed to methods that include generating a plurality of audit task templates based on a general audit assessment, associating each of the plurality of audit task templates with at least one business rule template, wherein each business rule template comprises logical translation information, associating a portion of the plurality of audit task templates to generate an audit template, and storing the audit template in a data store. In related embodiments, the plurality of audit task templates can include a model audit analysis definition. In other embodiments, the logical translation data comprises input parameters and output formats for a plurality of central management systems.

Other embodiments the present invention include retrieving, and audit template from the data store, and receiving business specific data from a user or external source.

In yet other embodiments, methods of the present invention can include generating an audit operation. Generating the audit operation can include generating a plurality of audit tasks by loading the business specific data into the audit task templates, and generating a plurality of business-specific business rules by loading the business-specific data into the business rule templates. Related embodiments can include generating a plurality of translated audit tasks by translating each of the audit tasks from a first format to a second format based on the business-specific business rules, wherein the second format is specific to a particular central management system.

In some embodiments, such methods can also include sending the translated audit tasks to the particular central management system, and receiving, in response to the translated audit tasks, a plurality of audit results.

Various embodiments the present action are directed towards systems that can include an audit manager, and a business rules database coupled to the audit manager. In such embodiments, the audit manager can generate a plurality of audit task templates based on a general audit assessment, associate each of the plurality of audit task templates with at least one business rule template, associate a portion of the plurality of audit task templates to generate an audit template, and store the audit template in a data store, wherein each business rule template that include logical translation information.

In other embodiments, the plurality of audit task templates can include a model audit analysis definition. The translation data can include input parameters and output formats for a plurality of central management systems.

In related embodiments, the audit manager can also retrieve the audit template from the data store and receive business specific data from a user or internal or external source.

In other embodiments, the audit manager can also generate an audit operation, wherein to generate the audit operation, the audit manager can instantiate a plurality of audit tasks by loading the business specific data into the audit task templates, and can generate a plurality of business-specific business rules by loading the business-specific data into the business rule templates.

In yet other embodiments, the audit manager can also generate a plurality of translated audit task by translating each of the audit tasks from a first format to a second format based on the business-specific business rules, wherein the second format is specific to a particular central management system.

In related embodiments, the audit manager can also send the translated audit tasks to the particular central management system, and receive, in response to the translated audit tasks, a plurality of audit results.

Other embodiments the present invention are directed towards non-transient computer readable medium that includes computer readable executable code, that when executed by processor. The computer system causes the processor to perform the methods described herein or generate the various tools, generators, editors, managers, and graphical user interfaces.

The following detailed description and accompanying drawings provide a better understanding of the nature and advantages of the present invention.

### BRIEF DESCRIPTION OF THE DRAWINGS

FIG. 1 illustrates a simplified schematic of a local audit management system, according to various embodiments the present invention.

FIG. 2 illustrates a simplified schematic of a local audit management system, according to various embodiments the present invention.

FIG. 3 illustrates a simplified schematic of a remote audit management system with multiple connections to multiple central management systems, according to various embodiments the present invention.

FIG. 4 illustrates a simplified schematic representation of an audit template according to various embodiments the present invention.

FIG. 5 illustrates a simplified schematic representation of a business rule according to various embodiments the present invention.

FIG. 6 is a general process flowchart of a method for generating and executing an audit according to various embodiments the present invention.

FIG. 7 is a flowchart for a method of generating an audit template according to various embodiments the present invention.

FIG. 8 is a flowchart of a method of executing an audit operation according to various embodiments the present invention.

FIG. 9 illustrates the computer system that can be used to implement various embodiments of the present invention.

### DETAILED DESCRIPTION

Described herein are techniques for systems and methods for defining and executing audits with automated data analysis. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Embodiments of the present invention are directed toward systems and methods for generating audit templates that include multiple audit tasks. The audit tasks include descriptions of specific steps for producing the desired audit information. Each audit task can also include associations to one or more business rules in a business rules database. The business rules can include mappings to one or more programs/applications in a central management system (CMS), such as enterprise resource planning (ERP) or customer relations management (CRM) systems, that execute the various operations/functions on the business data contained in the CMS. Once the programs return the results of the operations/function, the business rules can then translate results back to a form expected an audit management systems used to design and execute the audit template. Such embodiments can advantageously reduce the time and effort required to set up and execute an audit, while also increasing the accuracy, consistency, and thoroughness of audits from audit-period to audit-period. Once an audit template is created, it can be retrieved and reused in subsequent audits to ensure that the same audit tasks are being performed any sequential audit period.

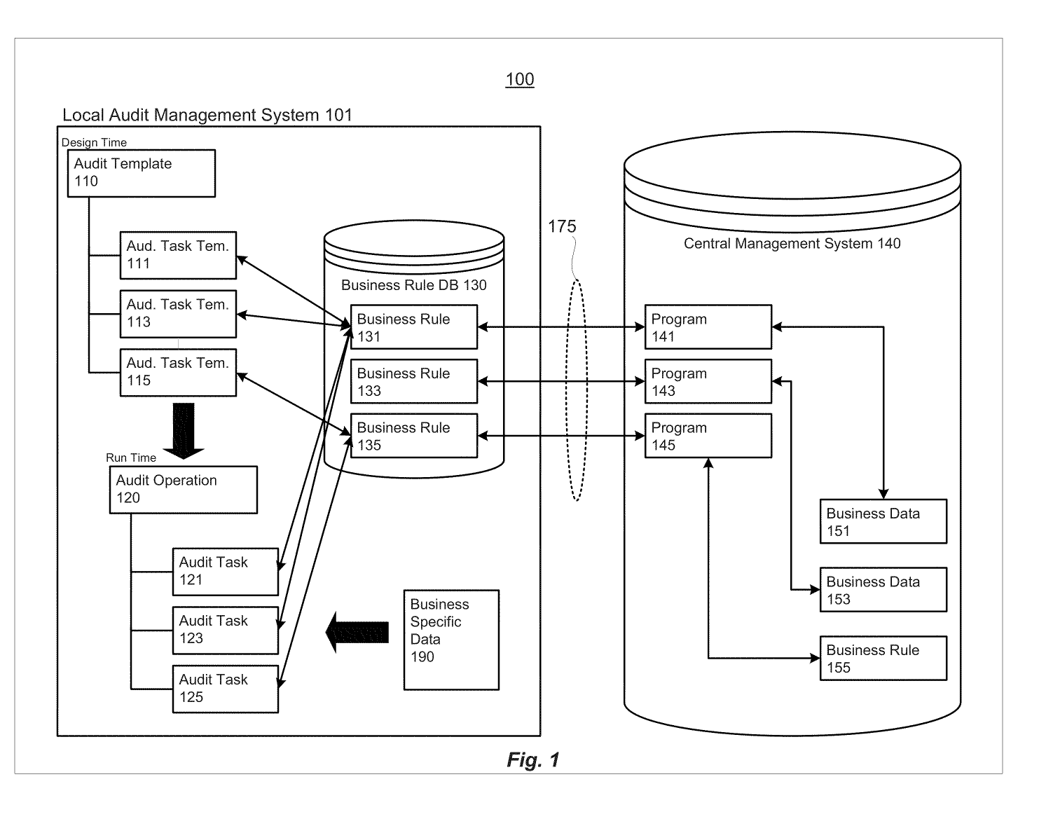

FIG. 1 shows a simplified schematic of a system 100 for generating and executing audits according to various embodiments of the present invention. The system 100 can include a local audit management system 101 coupled to a central management system (CMS) 140 through one or more connections 175. Such connections can be permanent or temporary wired or wireless network connections. In some embodiments, the local audit management system 101 can automatically setup the connections 175, while in other embodiments, the connections need to be set up manually. The local audit management system 101 can include one or more applications loaded onto or executed on one or more computer systems local to or linked to the CMS 140 by one or more electronic communication networks. The CMS 140 can include any type of or number of department or enterprise level business or financial transaction management systems, such as ERP or CRM systems.

According to various embodiments of the present invention, the local audit management system 101 can include computer executable code, that when executed by processor causes the processor to execute an audit template editor or audit template engine. The audit template editor can include a text-based or graphical user interface that can be used to design and generate an audit template 110. Audit template 110 can include specific information regarding how specific audit tasks are to be executed. In such embodiments, the audit template 110 can include a number of general task specifications that indicate various types of queries, calculations, reports, and other audit related operations and functions. Each general task specification can be embodied in an audit task template. Both the audit template 110 and each constituent audit task template can be generic and indiscriminate of a platform or computer language in which the tasks will ultimately be carried out. Such so-called platform agnosticism is advantageous in various embodiments of the present invention in which various or multiple types of CMS 140 are involved.

As shown, audit template 110 can include a number of defined audit task templates 111, 113, and 115. While only three audit task templates are shown in or associated with audit template 110, various embodiments of the present invention include more or fewer audit task templates assigned to the audit template 110. Each audit task template 111, 113, and 115 can include information regarding the specifics of a particular audit operation or report. Such audit task templates can include generic or model analysis information or definitions of various functions, formulas, and expressions for performing various type of audit-related and audit-specific analysis of business data. The generic definitions can be expressed in a general mark-up language or in a natural-language such that the generic definitions can be translated into one or more platform specific or application specific languages or formats quickly and efficiently at run time.

At design time, a user or automated system, such as a local audit management system 101, using a rules engine, can also configure one or more business rules. Business rules can define which tables, data structures, or applications in one or more central management systems will need to be referenced or accessed. The business rules can also include information regarding the analysis of the data contained in the referenced or accessed tables or data structures that will need to be performed. Accordingly, a business rule can include a listing of programs that can be invoked to access different database tables and perform analysis on the data in the tables. To define the specific bounds or limits on the analysis, each business rule template can include translation information for converting user or automated system inputs describing the specific metes and bounds a particular audit task into the specific selection parameters expected by the program or central management system invoked to complete the audit task. The selection parameters can include a specific or generic listing of the variables that one or more programs would need in order to access or invoke specific programs to perform various types of analysis. Such embodiments are described in more detail in reference to specific examples herein.

In related embodiments, each business rule 131, 133, and 135 can include information regarding various deficiency criteria and/or alert conditions to define under what circumstances and audit issue will need to be created. A deficiency criteria and/or alert condition information can include threshold and/or acceptable limits on various types of analysis, values, program outputs and other data contained in the central management system 140 or a related database.

In some embodiments, each business rule can include information or data regarding connection settings and protocols for requesting, establishing, setting up, or otherwise acquiring the network connections between the local audit management system 101 and the central management system 140. In such embodiments, the connection settings can include network communication protocols and security authentication requirements to allow each business rule in business rule database 130 of the local audit management system 110 to communicate with programs 141, 143, and 145, in the central management system 140 over connections 175. For example, such connection settings can include information regarding specific networking protocols, such as IEEE 802.11 or Ethernet, for initiating, establishing, conducting, authenticating, and concluding communication between local audit management system 101 and central management system 140 over connections 175. In such embodiments, connections 175 can include various types of wireless and wired communication media.

As shown in FIGS. 1, 2, and 3, each audit task template can be linked to one or more of the business rules in a business rule database. As discussed above, while only three exemplary audit task templates and three business rules are shown, one of ordinary skill in the art will recognize that the audit templates, and the business rule databases, can include more or fewer audit task templates and business rules without departing from the spirit and scope of the present invention. In some embodiments, each audit task template can include the information regarding the link to specific business rules needed to perform the translation between the audit task template and the program or database in the central management system. In other embodiments, a master list or table of contents can include the information for linking each specific audit task template to a specific business rule.

At runtime, or audit execution time, a user or audit engine creates an audit operation 120 based on audit template 110. The audit tasks templates 111, 113, and 115 are copied from audit template to audit operation 120. Audit tasks 121, 123, and 125 are based on audit task templates 111, 113, and 115 and the business specific data 190. Each of audit task 121, 123, and 125, can also include information linking each audit task to a specific business rule 131, 133, and 135 based on the respective link between specific audit task templates 111, 113, and 115. In one exemplary embodiment, audit task 121 includes link information linking it with business rule 131 based on the link information linking audit task template 111 with business rule 131. Similarly audit task 123 can include link information linking it with business rule 131 based on the link information linking audit task template 113 with business rule 131. Audit task 125 can include similar link information linking it with business rule 135 based on link information linking audit task template 115 with business rule 135.

In one exemplary embodiment, when audit template 110 is instantiated as audit operation 120, business specific data 190 is loaded into each of audit tasks 121, 123, and 125. While each audit task template 111, 113, and 115, can include the specific definitions of each audit operation or analysis, the audit tasks 121, 123, and 125, can include organization/process specific variables or values. For example, the business specific data 190 loaded into the audit tasks 121, 123, and 125 can include date ranges, regional or areas codes, product descriptions or codes, business operations, business divisions, etc. In such embodiments, specific data 190 can be loaded into audit task templates 111, 113, 115, to instantiate audit tasks 121, 123, and 125.

The business rule information from each of the business rules associated with or linked with the particular audit task templates can also be associated with or linked with the particular audit tasks. In some embodiments, information from the particular business rules linked to or associated with each particular audit task template can be copied into a corresponding particular audit task. In related embodiments, the audit operation 120 can be instantiated as a fully independent and executable piece of computer readable code capable of communicating with the local, remote central management system 140 and/or invoking the various programs, 141, 143, and 145, to access, retrieve, analyze, edit, or otherwise operate on business data 155, 153, and 155. In other embodiments, executing audit operation 120 can include referencing the instantiated audit operation 120 to perform various operations via business rules in the business rule database 130 with corresponding programs in the central management system 140 to operate on business data 151, 153, and 155.

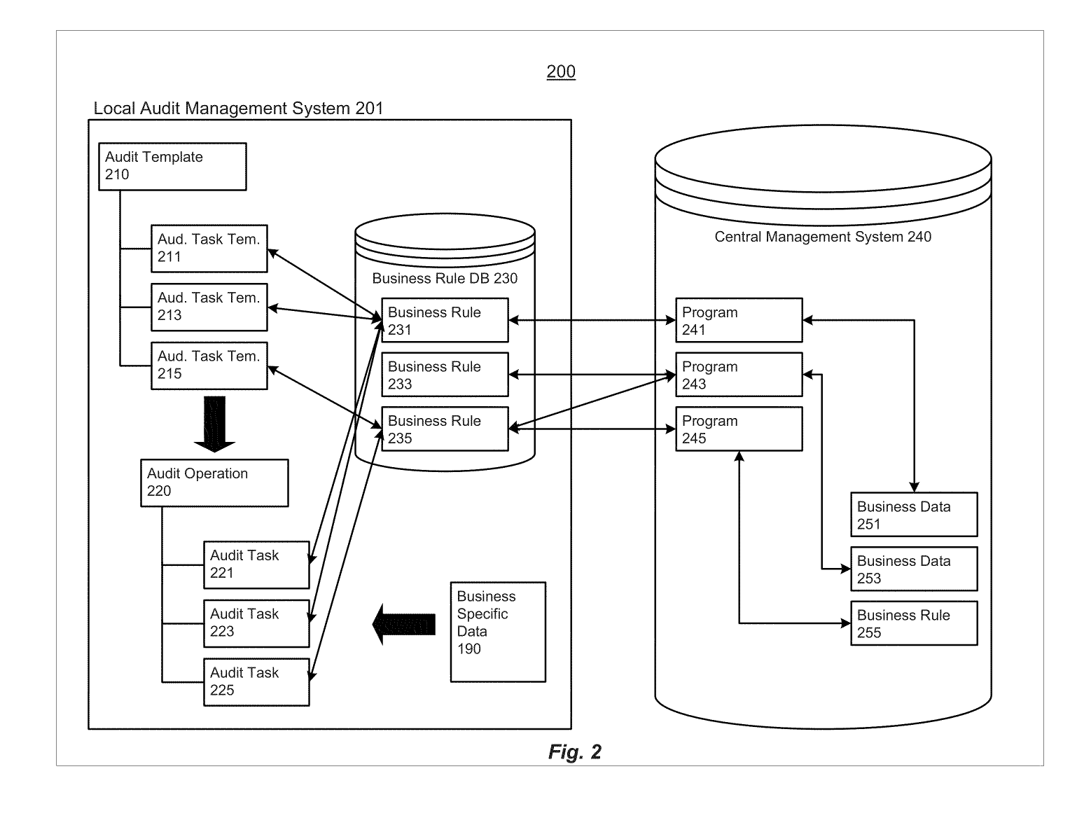

In some embodiments, as shown in FIG. 1, each business rule 131, 133, and 135, can include a one-to-one correspondence with programs 141, 143, and 145. In other embodiments, as shown in system 200 of FIG. 2, each business rule 231, 233, and 235, of business rule database 230 of local audit management system 201, can include a one-to-many correspondence between each business rule and the programs used to operate on the business data in the central management system 240. Specifically, business rule 231 can be linked to program 241, business rule 233 can be linked to program 243, while business rule 235 can be linked to program 243 and program 245. In such embodiments, a user or audit engine can create a complex and efficient audit template 210 with intricate and complex audit task templates 211, 213, and 215 that can draw on data and analysis performed by multiple programs of the central management system 240, without having to define additional business rule templates or business rules with a one-to-one correspondence with a specific program. Specifically, audit task 225 can be associated with or linked to a single business rule 235 that is linked to or associated with program 243 and program 245, which operate on business data 253 and business data 255, respectively. As shown, audit task 221 and audit task 223 can both be linked with business rule 231, while none of the audit task templates or audit tasks are linked with business rule 233 for the specific audit task templates 210 and audit operation 220.

Such embodiments advantageously simplify the mapping between a particular audit task and a single business rule. The complexity of design-time audit template creation is reduced, thus reducing the amount of training and time required for user to efficiently and effectively use various embodiments of the present invention. The complexity of the link between a particular audit task, such as audit task 215 and the business data required, such as business data 253 and 255, is reduced by mapping or linking the business rule 235 to programs 243 and 245, which operate on business data 253 and 255. Such embodiments alleviate the need for an end user to know about the underlying complexity of the mappings between a particular business rule and the programs required in a particular central management system to produce specific pieces of analysis defined by an audit template or instantiated audit operation.

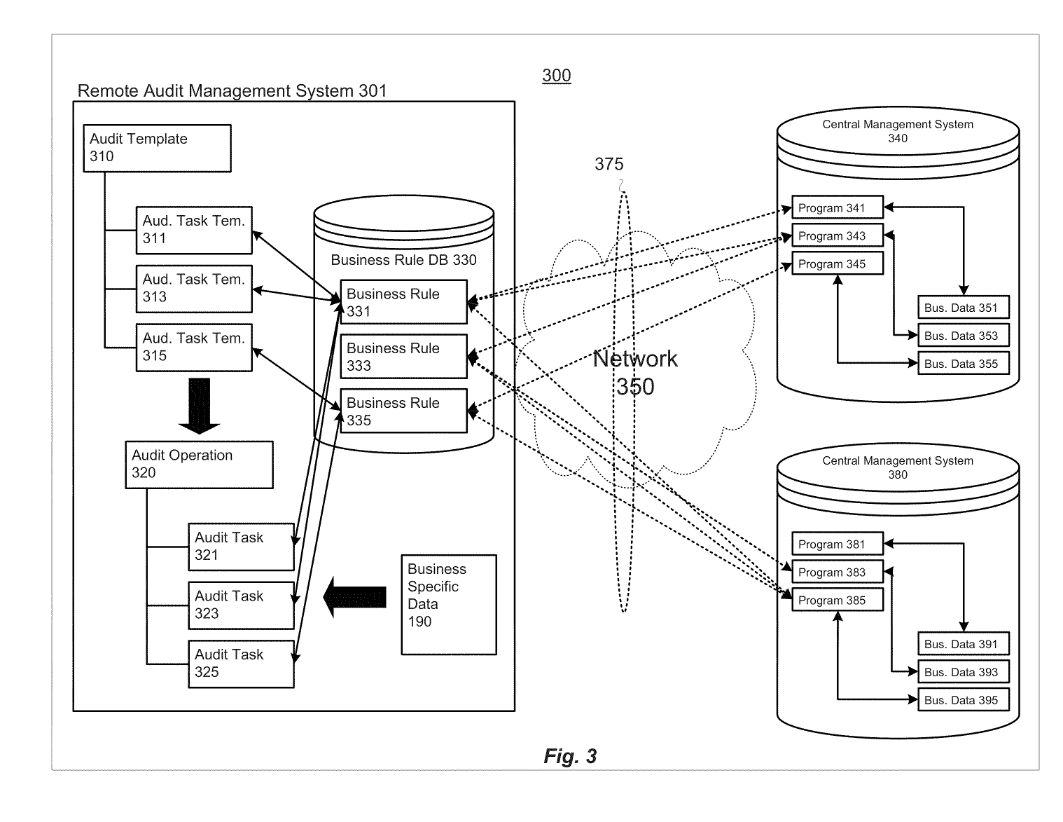

FIG. 3 shows yet another embodiment of a system 300 that includes a remote audit management system 301, that that can include multiple connections 375 with multiple central management systems 340 and 380. In such embodiments, the remote audit management system 301 can reside on a server computer, or be instantiated in a cloud computing configuration, to make connections with central management systems 340 and 380 over network 350, to facilitate performing audits based on audit template 310 and business rule database 330 without requiring specific data, applications, or programs be distributed to or installed on a system local to each of the central management systems 340 and 380. Such embodiments are particularly useful in scenarios in which the auditor or audit department of a particular organization is located in one location while central management systems 340 and 380 are located in remote locations, such as in remote divisions or overseas offices. For example, an auditor may implement a remote audit management system 301 when auditing multiple divisions of a single multinational corporation using multiple and/or disparate central management systems 340 and 380. Similarly, and auditing department of a single company encompassing multiple divisions or office locations, may use internal or virtual network 350 to run audits based on audit template 310 and business rules database 330 to operate on business data 351, 353, and 355 using programs 341, 343, and 345, in one central management system 340, and to operate on business data 391, 393, and 395 using programs 381, 383, and 385 in management system 380.

In embodiments, such as that shown in FIG. 3, audit operation 320 can include audit tasks 321, 323, and 325, instantiated from audit template 310 which can include audit task templates 311, 313, and 315. Each of the audit task templates 311, 313, and 315 and audit tasks 321, 323, and 325 can include information linking each particular audit task template and each particular audit task of a particular business rule in business rule database 330. System 300 differs from systems 100 and 200 in that each business rule 331, 333, and 335 of business rule database 330 can be linked to multiple programs in multiple central management systems over network. Accordingly, each business rule 331, 33, and 335 can include information or data regarding various disparate network communication and security protocols required to communicate with and authenticate the remote audit management system or an associated or logged on user with each central management system required for the particular audit template 310 or audit operation 320. Since the business rules in the business rule database 330 require various business specific communication and security information protocols, the business specific data 190, which can include such information, can be loaded into each respective audit task at runtime.

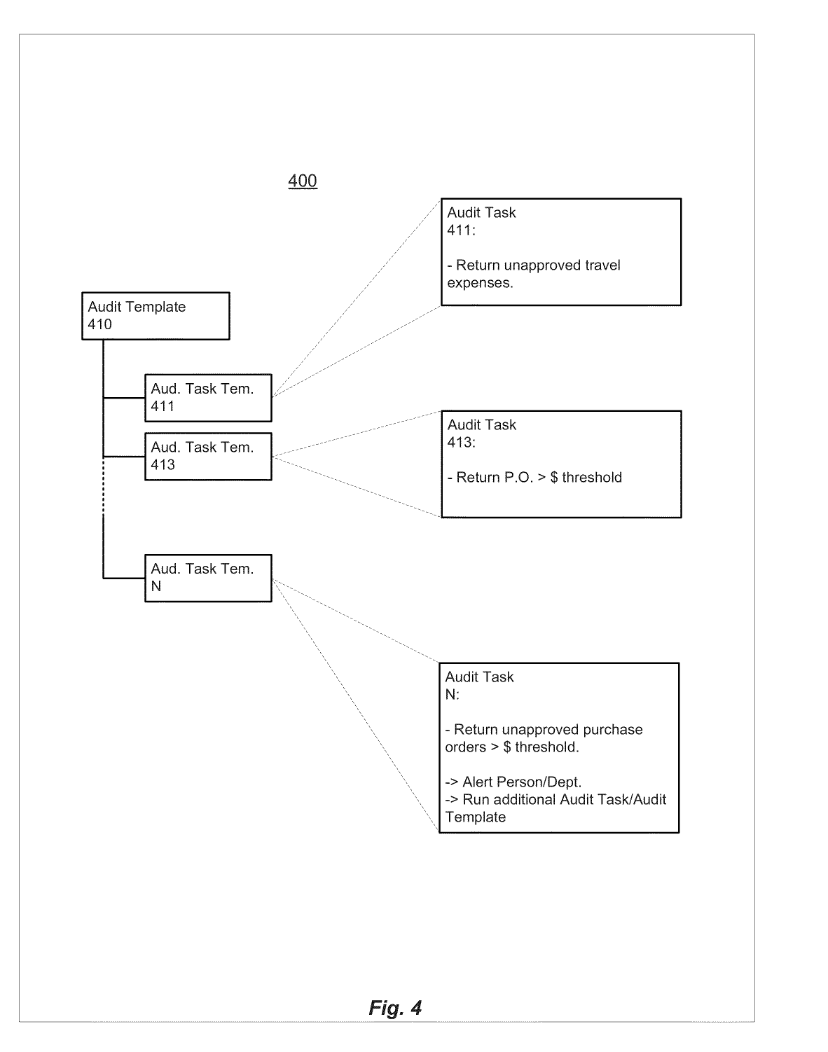

FIG. 4 is a simplified diagram 400 of an audit template 410, that can include N audit task templates 411, 413, to N, where N is a positive integer. In one exemplary embodiment, audit task 411 can include a definition of an audit task to return unapproved travel expenses. The definition for returning unapproved travel expenses can be independent of particular parameters, such as divisions of a company, date ranges, or threshold expense values. In another specific embodiment, audit task template 413 can include a definition of an audit task which will return purchase orders above a specific value threshold. Like audit task template 411, audit task template 413 can include an definition and instructions for running generic queries on a database to analyze data therein to determine records that involve purchase orders with values over a certain threshold value over a given period of time. However, like audit task template 411, audit task template 413. does not necessarily include information regarding specific parameters for the value threshold or the specific date range. Audit task template N is another specific example, which includes definition information and instructions for returning unapproved purchase orders over a given value threshold, and also includes instructions and generic definitions for issuing an audit issue if any unapproved purchase orders are returned. In the specific embodiment shown in FIG. 4, audit task template N defines that a person or department will be alerted and that another or additional audit task or audit task template will be run. Audit task N is a general definition and requires that the user or audit engine define the specific value threshold, the person or department that will be alerted, and indicate which additional audit task/audit task template should be loaded and executed.

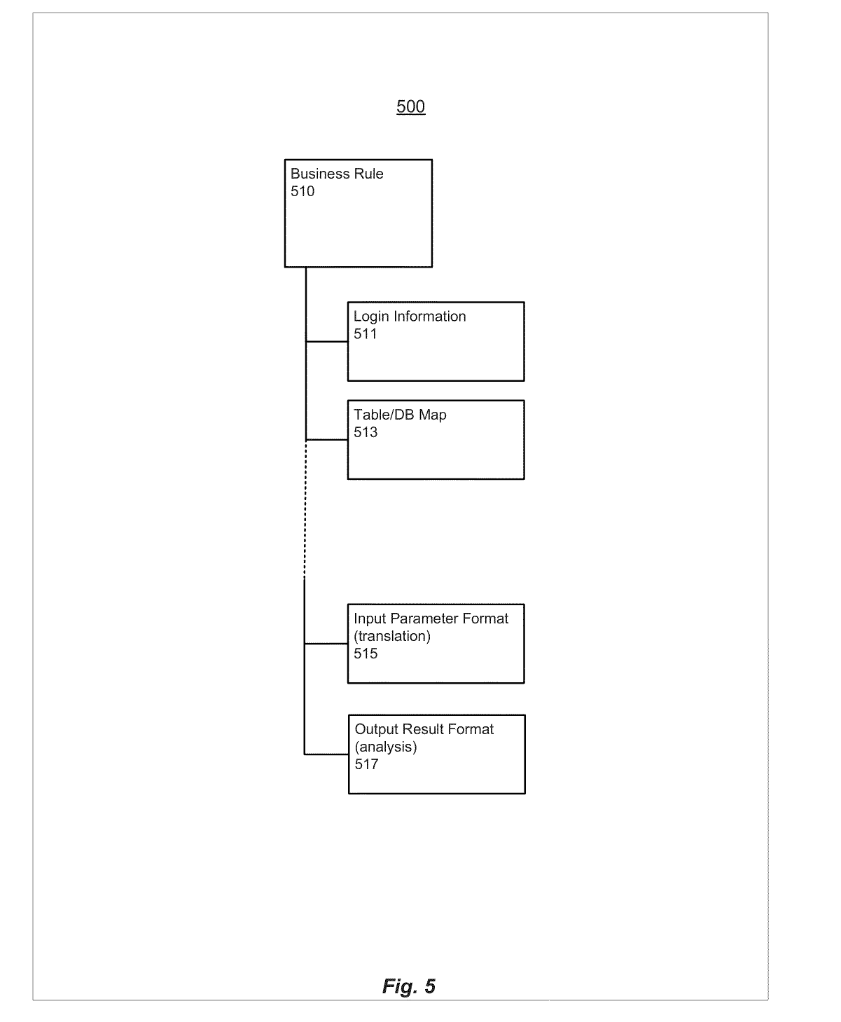

FIG. 5 is a simplified schematic 500 of a business rule 510, according to various embodiments of the present invention. As shown business will 500 and can include multiple pieces of information or data. For example, business rule 510 can include login information 511. Login information 511 can include specific security and authentication information for various users or organizations to access central management systems and other databases. Specifically, login information 511 can include administrator and/or lead auditor login information necessary for an instantiated audit operation to request, established, set up, authenticate, and terminate specific connections with local or remote central management systems and any programs and databases embodied therein. In some embodiments, login information can include specific network addresses for one or more multiple central management systems coupled to the computer or computing device in which the audit management system or business rule database is deployed.

Business rule 510 can also include table and database map information 513. Table and database map information 513 can include specific information regarding the titles, location, address, format, protocol, and other parameters required by a specific program in a corresponding database or central management system to operate on business or other data stored therein. For example, table or database map information 513 can include information regarding a specific parameter set required to access a given table or table type in a given database or database type. Such information can include IP addresses and file names in the specific addressing format with parameters that can be loaded from business specific data 190. In related embodiments, table and database map information 513 can include table categorization and data record ID information or protocols required to access and properly interpret data stored in tables of a given database. A user or business rule engine can supply the business specific data to complete the information in the table and database map information 513 to provide corresponding programs in the desired table or database with an appropriately formatted data request, command, or other operation.

In other embodiments, business rule 510 can also include input parameter format/translation information 515. Such information can include information for translating operations from the native form of a specific audit task template or audit operation into the command, protocol, format, or other program specific input parameter standard. For example, business rule 510 can include translation information for translating Visual Basic or SQL type definitions in a specific audit task template or audit task to the native query language of a remote or local central management system, such as an SAP™ or Oracle™ ERP system, which may run on open standard or proprietary programming or database languages.

In yet other specific exemplary embodiments, business rule 510 can include an output request format or analysis information 517. Such information can include translation information and/or definitions of the format or protocol in which information is returned from a specific central management system to the audit management system in response to a specific instantiated audit task template or a specific audit task. In related embodiments, output result format or analysis information 517 can include the format or protocol output from a specific program invoked during a particular audit operation. Such information can be used to reformat the analysis, deficiency criteria, alert condition, or other audit issue information, into a format or protocol that can be used by the audit management system to alert a user, or other system.

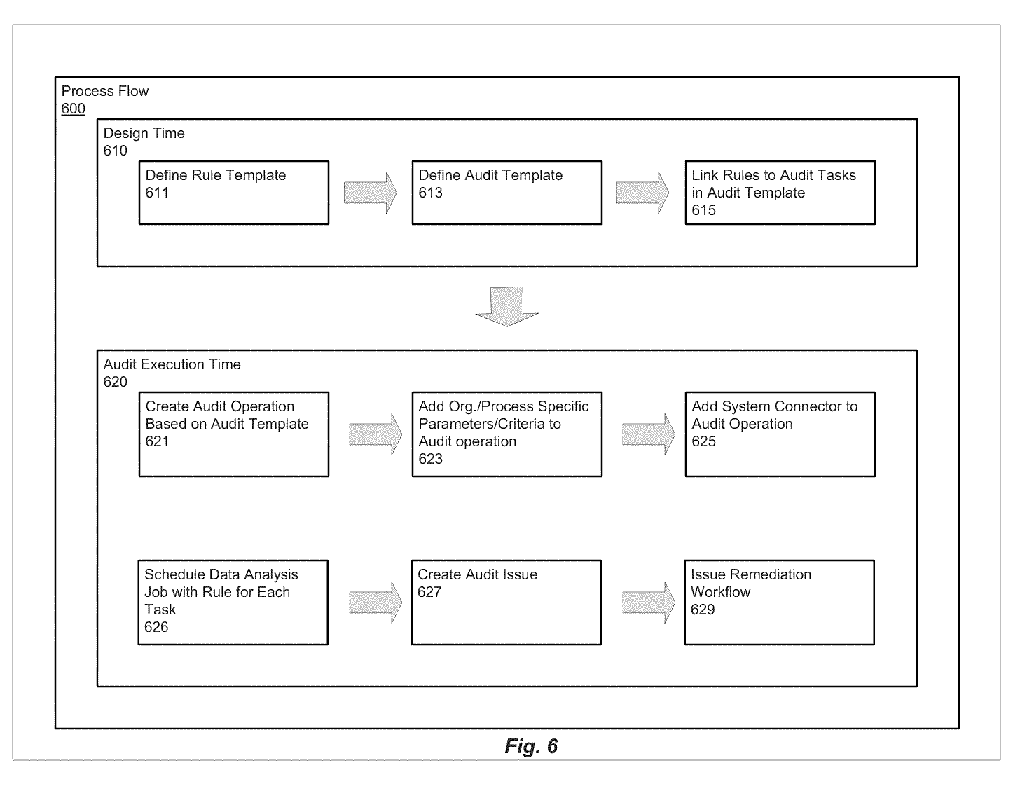

FIG. 6 is a simplified process flowchart 600 according to various embodiments of the present invention. In such embodiments, processes, and methods of the present disclosure can be separated into design time 610 and audit execution time 620. As shown design time 610 can include using various tools, programs, or engines of an audit management system to define business rule templates in step 611, as described herein. Each business rule template can include multiple business rules. Once one or more business rule templates are defined, a user or automated system can use associated tools, programs, or engines of an audit management system to define audit templates in step 613. As described herein, audit templates can include multiple audit task templates.

At step 615, business rule templates can be linked to audit templates. In such embodiments, individual business rules of the business rule template can be specifically linked or associated to audit task templates of the audit templates. Each of the business rule templates, audit templates, the underlying business rules, audit task templates, and a corresponding associations or links can be saved to a data store for immediate or later use.

With one or more stored collections of business rule templates, audit templates, underlying business rules templates, audit task templates, and corresponding association or links, a user or automated system can use an audit management system to retrieve and/or run a stored collection in audit execution time 620. In such embodiments, a user or automated system can use an audit management system to create an audit operation based on a stored or retrieved audit template in step 621. The user or automated system can then load or add organization/process specific parameters and criteria into each audit task templates of the audit template in step 623. In some embodiments, it is necessary to include system connectors or communication channels to the audit operation, in step 625, to enable proper and authenticated communication with a remote or local central management system, such as an ERP system. With all the business and process specific parameters and deficiency criteria added to the audit operation, the audit management system can schedule timeslots or data analysis jobs or execution operations for each audit task in step 626. In the event that any alert conditions or deficiency criteria are detected during a scheduled data analysis job, the automated system can determine to make or create an audit issue in step 627. If any audit issues are created, various embodiments of the present invention can include issuing a remediation workflow to correct or investigate such alert conditions or deficiency criteria in step 629. In various embodiments, an audit issue remediation workflow can include alerting a specified user or department for further investigation or analysis. In other embodiments, initiating remediation workflow can include retrieving a pre-specified audit template or audit operation to perform additional analysis or to determine additional deficiency criteria or alert conditions.

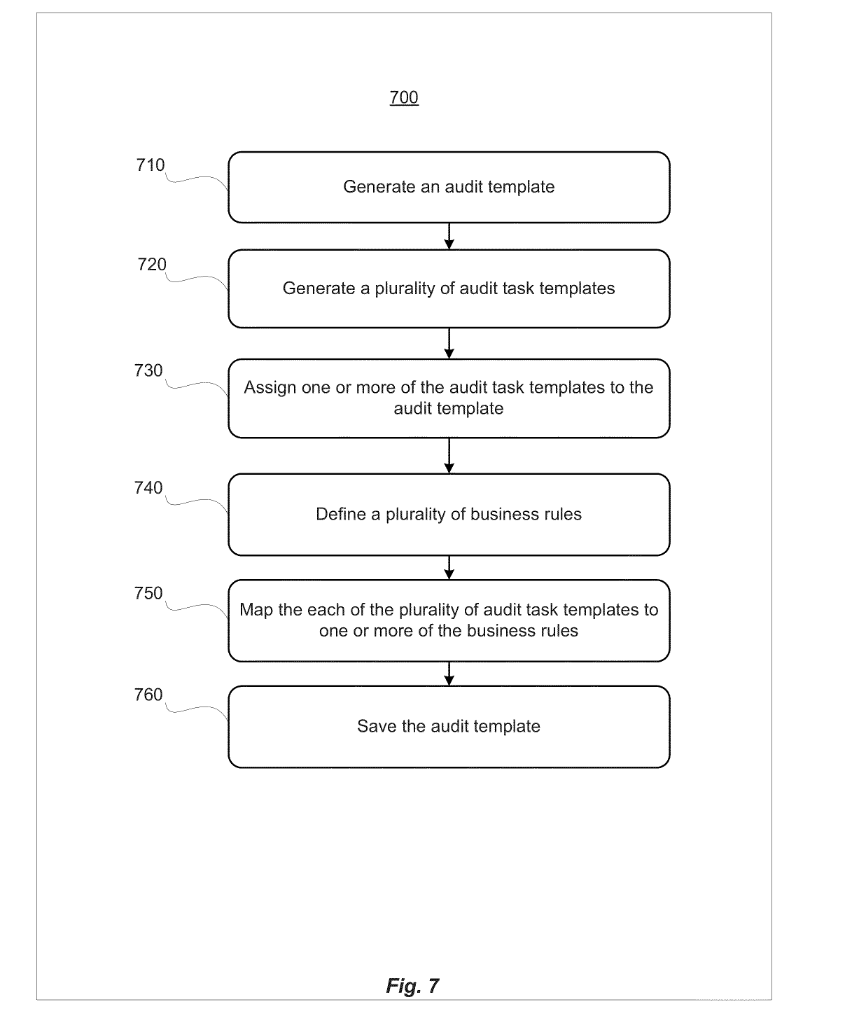

FIG. 7 is a flowchart of a method 700 according to various embodiments of the present invention. At step 710, a user or automated system, can generate audit template using an audit template editor or audit template engine. The audit template can include a generic description for a particular set of audit tasks that need to be performed during a particular audit. In some embodiments, and audit template can include a collection of audit templates. A user or automated system can create a plurality of audit task templates, in step 720. Each one of the audit task templates can include a generic language and platform independent description of how a particular audit task should be performed. Accordingly, each audit task can include an expression, formula, or pseudocode description of the particular of steps for the desired audit task. In step 730, one or more audit task templates can be assigned to one or more audit templates. As such, each audit template can include multiple audit task templates that, in combination, describe a particular set of instructions or a sequence of instructions to perform a particular set of tasks in a particular audit. For example, one audit template can be directed towards auditing various types of travel expenses, while another audit template can be directed towards detecting various types of unapproved purchase orders.

In step 740, a user or automated system, using a business rule editor or business rule engine, can define a plurality of business rules. Each of the business rules can include translation information for converting instantiated audit templates into language and platform specific requests to various programs and databases of specific types of central management systems. Business rules can include information for determining which programs of a particular type of central management system should be invoked to operate on specific tables or databases necessary for returning the desired results defined as in a related audit task. In related embodiments, the business rules can also include translation information and parametric information for interpreting and parsing results, and other messages received from a particular central management system. In some embodiments, the business rules can also include business specific deficiency criteria for judging the results of a particular audit task. In related embodiments, the business rules will also include information that defines actions that you should occur in the event that deficiency criteria is detected. In some embodiments, the process of detecting the deficiency criteria can include creating an audit issue or ticket. In step 750, each audit task templates in the particular audit template can be mapped or linked to one or more business rules. In step 760, each audit template that includes a number of audit task templates and information mapping each audit task templates to a business rule can be saved to one or more data stores accessible to an audit management system for immediate or future use.

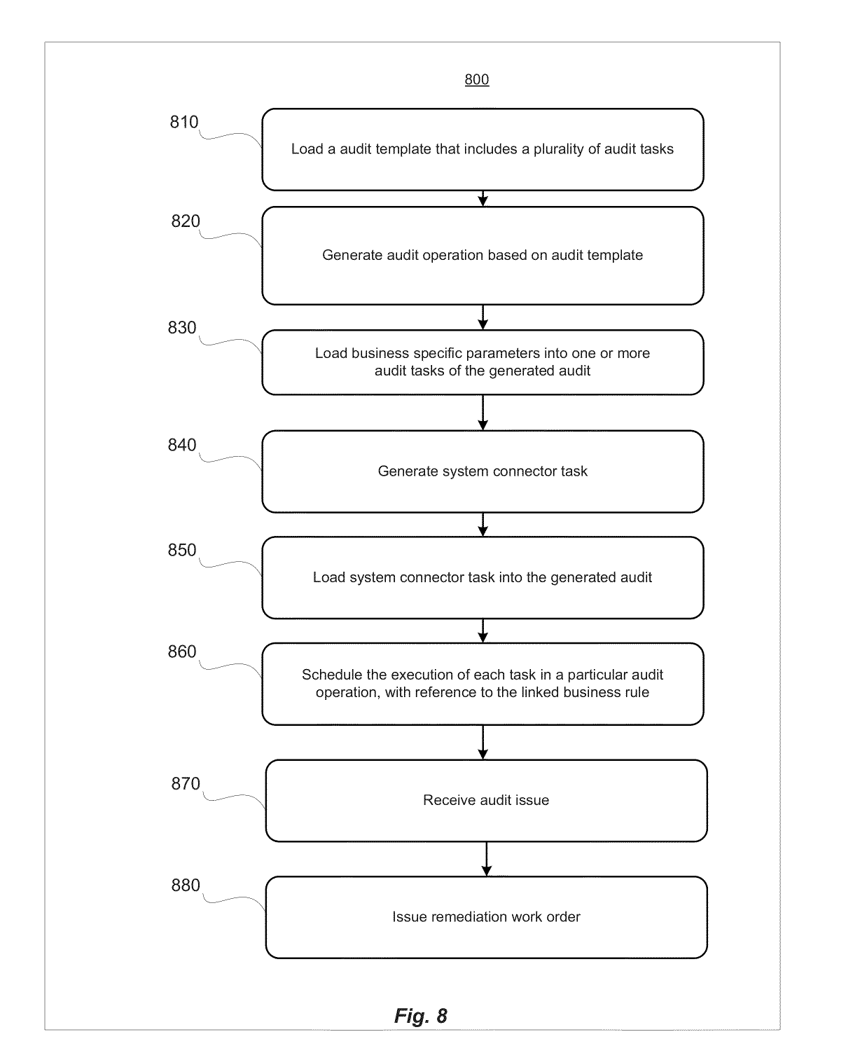

FIG. 8 shows a flowchart 804 method of instantiating a predetermined audit according to various embodiments of the present invention. In step 810, a user or automated system, such as an audit management system, can load an audit template from an accessible or local data store. The audit template can include a plurality of audit task templates that describe individual audit tasks. In step 820, the audit management system can create an audit operation as an instance of the loaded audit template. The instantiated audit template, or audit operation, can include a number of audit tasks that are instantiated from multiple audit task templates associated with the particular audit template. Step 330, the audit management system can load business specific parameters into one or more of the audit tasks of the generated audit operation. In various embodiments, the business specific parameters can include information regarding the specific desired parameters and/or results of a particular audit task. For example business specific parameters can include date ranges, regional codes, product codes, threshold amounts, authorization types, etc. Such specific business parameters are inserted into the audit task template variables to complete the description of a specific audit task.

In related embodiments, the audit management system, can generate a system connector task, in step 840. The system connector task can include a set of instructions, standards, or protocols automatically generated in the audit management system for requesting, establishing, setting up, testing, and terminating specific connections over various types of communication media with one or more central management systems. In some embodiments, the system connector task can include information for simultaneous or sequential connections with one or more central management systems over a local data bus or external network, such as the Internet. In some embodiments, in step 850, the audit management system can load the system connector task into one or more the generated audit operations.

At step 860, the audit management system can schedule the execution of each audit task and in particular audit operation, with reference to the associated or linked business rule. In such embodiments, the automated system can take advantage of slow or down time for specific or specific types of central management systems. For example, the audit management system can schedule audit operations to be run overnight when transaction volumes or reconciliation activity is at a minimum to decrease the interference with regular business operations being performed by the central management system or increase the speed with which each audit operation can be executed.

In related embodiments, the audit management system can also receive audit issue information based on predetermined deficiency criteria and/or alert conditions defined in the audit templates, the audit task templates, or the business rules, in step 870. For example, the efficiency criteria and/or alert conditions can include minimum and maximum threshold values and/or flags for unauthorized or unauthenticated transactions. In step 880, in the event that the audit management system receives an audit issue, the audit management system can automatically initiate an issue remediation work order. In some embodiments, issuing the remediation work order can include loading predetermined audit templates or a set of audit templates that include a number of audit task templates, instantiating such templates to create a number of audit operations and audit tasks using various types of business specific information to collect, investigate, and/or correct the condition that caused the audit issue to be generated. In other embodiments, issuing the remediation work order can include sending a message or alert to particular user or department based on the business specific information used to instantiate the audit operation.

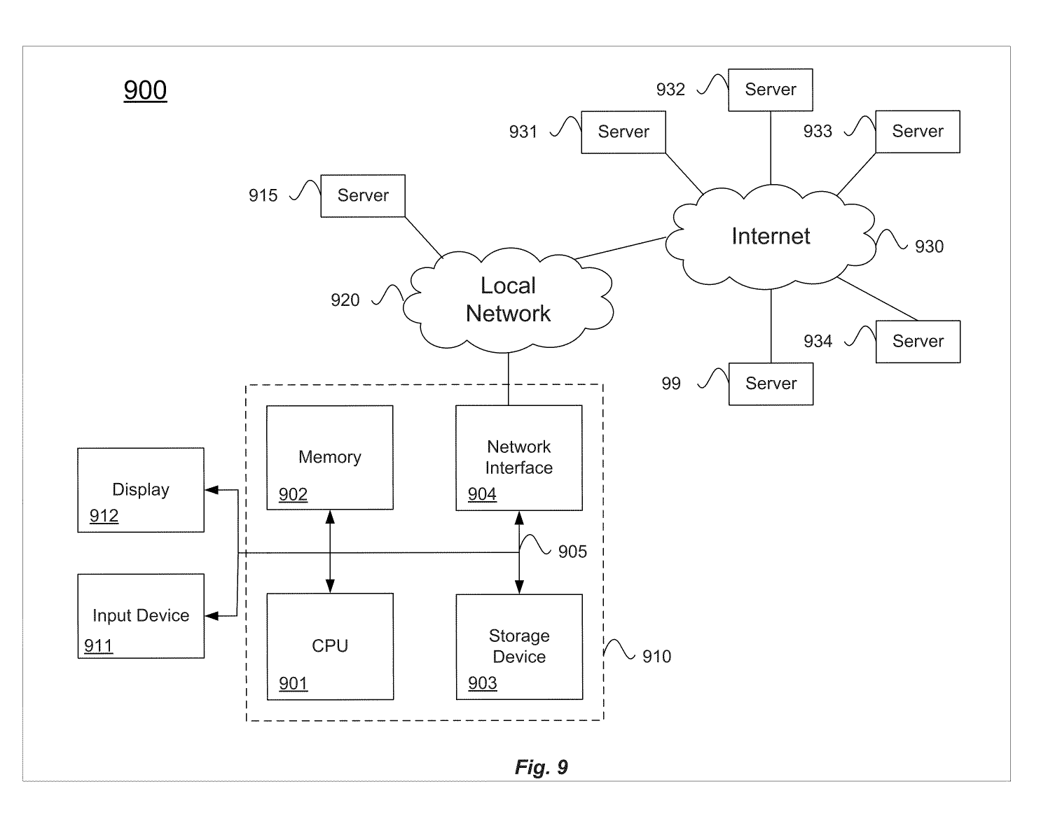

FIG. 9 illustrates an example computer system and networks that may be used to implement one embodiment of the present invention. Computer system 910 includes a bus 905 or other communication mechanism for communicating information, and a processor 901 coupled with bus 905 for processing information. Computer system 910 also includes a memory 902 coupled to bus 905 for storing information and instructions to be executed by processor 901, including instructions for performing the techniques described above. This memory may also be used for storing temporary variables or other intermediate information during execution of instructions to be executed by processor 901. Possible implementations of this memory may be, but are not limited to, random access memory (RAM), read only memory (ROM), or both. A storage device 903 is also provided for storing information and instructions. The information instructions can be in the form of computer readable code stored on the storage device, accessible and executable by processor to implement various techniques and methods of the present disclosure. Common forms of storage devices include non-transient, non-volatile computer readable media, for example, a hard drive, a magnetic disk, an optical disk, a CD, a DVD, a flash memory, a USB memory card, or any other medium from which a computer can read.

Computer system 910 may be coupled via the same or different information bus, such as bus 905, to a display 912, such as a cathode ray tube (CRT) or liquid crystal display (LCD), for displaying information, such as the graphical user interface audit management system, a business rule engine, and audit template engine, or other user interface according to various embodiments the present invention. An input device 911 such as a keyboard and/or mouse is coupled to a bus for communicating information and command selections from the user to processor 901. The combination of these components allows the user to communicate with the system.

Computer system 910 also includes a network interface 904 coupled with bus 905. Network interface 904 may provide two-way data communication between computer system 910 and the local network 920. The network interface 904 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 904 sends and receives electrical, electromagnetic, or optical signals that carry digital data streams representing various types of information.

Computer system 910 can send and receive information, including messages or other interface actions, through the network interface 904 to an Intranet or the Internet 930. In the Internet example, software components or services may reside on multiple different computer systems 910 or servers 931 across the network. Software components described above may be implemented on one or more servers. A server 931 may transmit messages from one component, through Internet 930, local network 920, and network interface 904 to a component or container on computer system 910, for example. Software components of a composite application may be implemented on the same system as other components, or on a different machine than other software components. This process of sending and receiving information between software components or one or more containers may be applied to communication between computer system 910 and any of the servers 931 to 935 in either direction. It may also be applied to communication between any two servers 931 to 935.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
generating, in a computer system, a plurality of audit task templates based on a general audit assessment;
associating in the computer system, each of the plurality of audit task templates with at least one business rule template, wherein each business rule template comprises logical translation information;
associating, in the computer system, a portion of the plurality of audit task templates to generate an audit template; and
storing the audit template in a data store.

2. The method of claim 1 wherein each of the plurality of audit task templates comprises a model audit analysis definition.

3. The method of claim 1 wherein the logical translation data comprises input parameters and output formats for a plurality of central management systems.

4. The method of claim 1 further comprising retrieving, in the computer system, the audit template from the data store, and receiving, in the computer system, business specific data.

5. The method of claim 4 further comprising generating, in the computer system, an audit operation, wherein generating the audit operation comprises:
generating a plurality of audit tasks by loading the business specific data into the audit task templates; and
generating a plurality of business-specific business rules by loading the business-specific data into the business rule templates.

6. The method of claim 5 further comprises generating a plurality of translated audit tasks by translating each of the audit tasks from a first format to a second format based on the business-specific business rules, wherein the second format is specific to a particular central management system.

7. The method of claim 6 further comprising sending the translated audit tasks to the particular central management system, and receiving, in response to the translated audit tasks, a plurality of audit results.

8. A system comprising:
an audit manager;
a business rules database coupled to the audit manager,
wherein in the audit manager generates a plurality of audit task templates based on a general audit assessment, associates each of the plurality of audit task templates with at least one business rule template, associates a portion of the plurality of audit task templates to generate an audit template, and stores the audit template in a data store,
wherein each business rule template comprises logical translation information.

9. The system of claim 8 wherein each of the plurality of audit task templates comprises a model audit analysis definition.

10. The system of claim 8 wherein the logical translation data comprises input parameters and output formats for a plurality of central management systems.

11. The system of claim 8 wherein the audit manager further retrieves the audit template from the data store and receives business specific data.

12. The system of claim 11 wherein the audit manager further generates an audit operation, wherein to generate the audit operation, the audit manager generates a plurality of audit tasks by loading the business specific data into the audit task templates, and generates a plurality of business-specific business rules by loading the business-specific data into the business rule templates.

13. The system of claim 12 wherein the audit manager further generates a plurality of translated audit task by translating each of the audit tasks from a first format to a second format based on the business-specific business rules, wherein the second format is specific to a particular central management system.

14. The system of claim 13 further comprising sending the translated audit tasks to the particular central management system, and receiving, in response to the translated audit tasks, a plurality of audit results.

15. A non-transient computer readable medium comprising:
executable code, that when executed by a processor, causes the processor to generate a plurality of audit task templates based on a general audit assessment, associate each of the plurality of audit task templates with at least one business rule template, associate a portion of the plurality of audit task templates to generate an audit template, and store the audit template in a data store, wherein each business rule template comprises logical translation information.

16. The non-transient computer readable medium of claim 15 wherein the logical translation data comprises input parameters and output formats for a plurality of central management systems.

17. The non-transient computer readable medium of claim 15 wherein the audit manager further retrieves the audit template from the data store and receives business specific data.

18. The non-transient computer readable medium of claim 17 wherein the executable code further causes the processor to generate an audit operation, wherein to generate the audit operation, wherein the executable code further causes the processor to generate a plurality of audit tasks by loading the business specific data into the audit task templates, and generate a plurality of business-specific business rules by loading the business-specific data into the business rule templates.

19. The non-transient computer readable medium of claim 18 wherein the executable code further causes the processor to generate a plurality of translated audit tasks by translating each of the audit tasks from a first format to a second format based on the business-specific business rules, wherein the second format is specific to a particular central management system.

20. The non-transient computer readable medium of claim 19 wherein the executable code further causes the processor to send the translated audit tasks to the particular central management system, and receiving, in response to the translated audit tasks, a plurality of audit results.
